(19) United States
(12) Patent Application Publication
(10) Pub. No.: US 2022/0027885 A1
(43) Pub. Date: Jan. 27, 2022

(54) PORTABLE POINT-OF-SALE TERMINAL

(71) Applicant: UNIFORM INDUSTRIAL CORP., New Taipei City (TW)

(72) Inventors: Attlee Lo, New Taipei City (TW); Hsi-Wen Lee, New Taipei City (TW); Tsung-Hsin Shen, New Taipei City (TW)

(21) Appl. No.: 17/006,263

(22) Filed: Aug. 28, 2020

(51) Int. Cl. G06Q 20/32; H04B 17/318; H04W 4/029; H04W 24/02; G06Q 20/20

(52) U.S. Cl. CPC G06Q 20/325; H04B 17/318; G06Q 20/20; H04W 24/02; H04W 4/029

(57) ABSTRACT

A portable point-of-sale terminal is provided, including: a communication module configured to search for a network signal of a wireless network base station for communication; a transaction module configured to perform a transaction procedure; a detection module configured to perform a detection procedure for detecting a signal strength and a network channel of the wireless network base station; a processing module configured to: when the transaction module starts the transaction procedure, drive the detection module to perform the detection procedure; and when it is detected that the signal strength meets a default condition, allow the transaction procedure, and generate a prompt signal to be completed; or when it is detected that the signal strength does not meet the default condition, generate a warning signal; and a display module configured to display prompt information or warning information.

### CROSS-REFERENCE TO RELATED APPLICATION

This non-provisional application claims priority under 35 U.S.C. § 119(a) to Patent Application No. 109209477 in Taiwan, R.O.C. on Jul. 23, 2020, the entire contents of which are hereby incorporated by reference.

### BACKGROUND

### Technical Field

The present invention relates to a point-of-sale terminal, and in particular, to a portable point-of-sale terminal.

### Related Art

A current trading system is generally accustomed to performing a trading procedure through an electronic device. When most electronic devices perform transaction procedures, the electronic devices need to connect to a host system through a network to complete the transaction procedures. However, when a point-of-sale terminal is used for a transaction procedure in a Wi-Fi network, a use environment may occupy a large space. For example, in a restaurant, a Wi-Fi signal may not be strong enough, or a channel may be occupied by too many users, resulting in a failure in the transaction procedure.

### SUMMARY

In view of the above, the present invention provides a portable point-of-sale terminal, including: a communication module configured to search for a network signal of a plurality of wireless network base stations in a use environment, and connect to one of the wireless network base stations for communication after the network signal is found; a transaction module configured to perform a transaction procedure, the transaction procedure being performed through the communication module and a remote financial institution when payment information is received; a detection module configured to perform a detection procedure, the detection procedure being used for detecting a signal strength and a network channel of the wireless network base station received by the communication module; a processing module configured to: when the transaction module starts the transaction procedure, drive the detection module to perform the detection procedure; and when the detection module detects that the signal strength meets a default condition, allow the transaction module to complete the transaction procedure, and generate a prompt signal; or when the detection module detects that the signal strength does not meet the default condition, generate a warning signal, drive the communication module to switch the network channel or drive the communication module to connect to another wireless network base station, re-drive the detection module to perform the detection procedure, and allow the transaction module to complete the transaction procedure until the signal strength meets the default condition; and a display module configured to display prompt information according to the prompt signal or display warning information according to the warning signal.

Further, when the transaction module does not perform the transaction procedure, the processing module drives the detection module to detect the signal strength of the wireless network base station received by the communication module, and the display module displays a network status message according to the signal strength.

In addition, when the transaction module is performing the transaction procedure, the processing module re-drives the detection module to perform the detection procedure at intervals of a default time.

Further, the portable point-of-sale terminal further includes a first position locating module configured to locate a position of the wireless network base station according to the signal strength, the display module displaying map information and the position of the wireless network base station in the map information.

The portable point-of-sale terminal further includes a background database configured to store position information of the wireless network base stations, the first position locating module obtaining the position information of the wireless network base stations through the communication module, and when the communication module is connected to the one of the wireless network base stations for communication, the first position locating module locating the position of the wireless network base station to which the communication module is connected.

In addition, the portable point-of-sale terminal further includes a second position locating module configured to obtain position information according to a global positioning system and a 3G, 4G, or 5G signal, the first position locating module locating the position of the wireless network base station according to the signal strength and the position information.

When a quantity of users connected to the wireless network base station exceeds a default value, the processing module automatically switches the network signal connected to the other wireless network base stations.

Detailed features and advantages of the present invention are described in detail in the following implementations, and the content of the implementations is sufficient for a person skilled in the art to understand and implement the technical content of the present invention. A person skilled in the art can easily understand the objectives and advantages related to the present invention according to the contents disclosed in this specification, the claims and the drawings.

### BRIEF DESCRIPTION OF THE DRAWINGS

FIG. 1 is a schematic diagram of a use environment of a portable point-of-sale terminal according to the present invention.

FIG. 2 is a block diagram of a portable point-of-sale terminal according to the present invention.

FIG. 3 is a block diagram of a portable point-of-sale terminal according to another embodiment of the present invention.

FIG. 4 is a block diagram of a portable point-of-sale terminal according to still another embodiment of the present invention.

FIG. 5 is a block diagram of a portable point-of-sale terminal according to yet another embodiment of the present invention.

### DETAILED DESCRIPTION

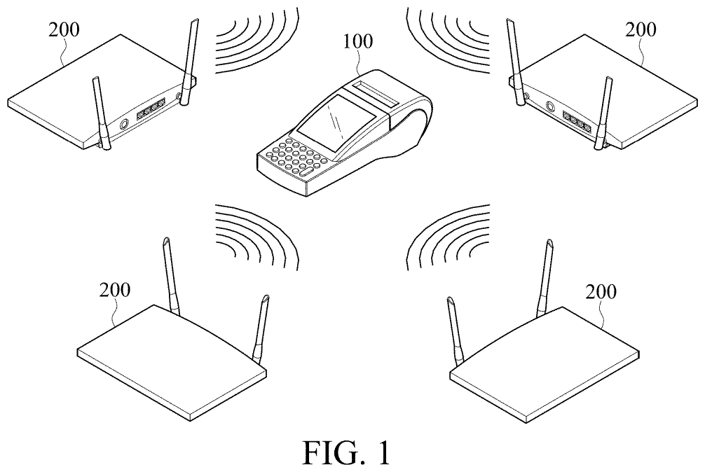

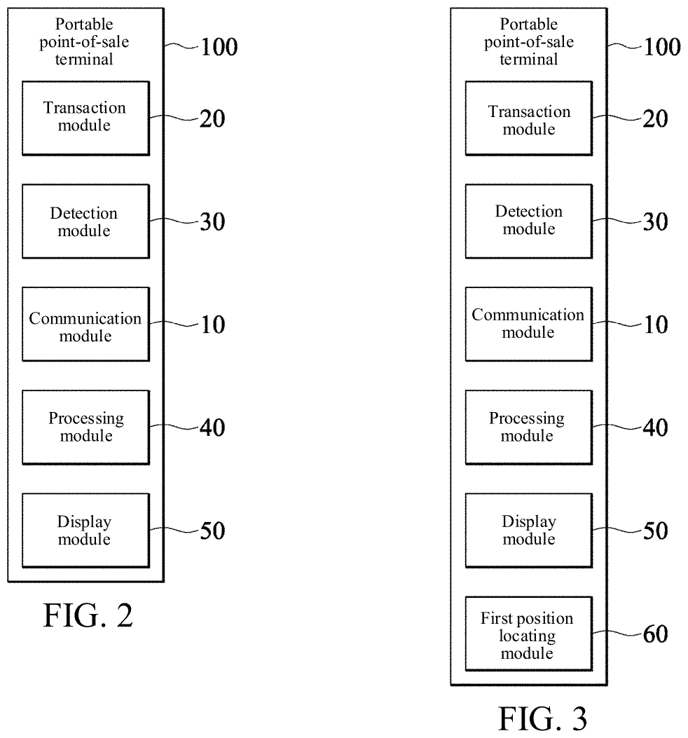

Referring to FIG. 1 and FIG. 2, FIG. 1 is a schematic diagram of a use environment of a portable point-of-sale terminal according to the present invention. FIG. 2 is a block diagram of a portable point-of-sale terminal according to the present invention. A portable point-of-sale terminal 100 of the present invention can be used with a plurality of wireless network base stations 200, for example, Wi-Fi access points. When the portable point-of-sale terminal 100 is in use, the portable point-of-sale terminal is first connected to one of the wireless network base stations 200. The portable point-of-sale terminal 100 of the present invention includes: a communication module 10, a transaction module 20, a detection module 30, a processing module 40, and a display module 50.

The communication module 10 may search for a network signal of a plurality of wireless network base stations 200 in a use environment, and connect to one of the wireless network base stations 200 for communication after the network signal is found. Herein, the communication module 10 is a 3G, 4G, 5G, or Wi-Fi module, but is not limited thereto.

The transaction module 20 is configured to read payment information of a customer to perform a transaction procedure. Further, when the transaction module 20 is performing the transaction procedure, the transaction procedure is performed through the communication module 10 and a remote financial institution when payment information is received. For example, when a customer needs to check out after a meal, a user can read, through the transaction module 20, a credit card or a financial card used by the customer or information provided through electronic payment. Herein, the credit card, the financial card, the electronic payment, or the like is payment information of the customer, but is not limited thereto. In some embodiments, the transaction module 20 preferably includes a card reader or a camera. The credit card of the customer is read through the card reader, or a QR code provided by the customer is shot through the camera to read the payment information of the customer to execute the transaction procedure.

The detection module 30 is configured to perform a detection procedure, the detection module 30 detecting a signal strength and a network channel of the received wireless network base station 200, for example, a current channel of the wireless network base station 200 connected to the portable point-of-sale terminal 100, or a quantity of bars of the signal strength of the connected wireless network base station 200.

The processing module 40 may preferably be, for example, a central processing unit (CPU), or a processing unit with a processing program function. When the transaction module 20 starts the transaction procedure, the processing module 40 drives the detection module 30 to execute the detection procedure. When the detection module 30 detects that the signal strength of the received wireless network base station 200 meets a default condition, the transaction module 20 is allowed to complete the transaction procedure and a prompt signal is generated. In other words, the payment information received by the transaction module 20 may be used to perform the transaction procedure through the communication module 10 and the remote financial institution, and prompt information such as “transaction completed” is generated.

When the detection module 30 detects that the signal strength of the received wireless network base station 200 does not meet the default condition, a warning signal is generated. In other words, if the signal strength does not meet the default condition, a warning signal such as “insufficient signal strength” is generated. In addition, when the signal strength does not meet the default condition, the processing module 40 drives the communication module 10 to switch the network channel, or drive the communication module 10 to connect to another wireless network base station 200, and allow the transaction module 20 to complete the transaction procedure until the detection module 30 detects that the signal strength of the received wireless network base station 200 meets the default condition. In other words, when the network channel is switched or another wireless network base station 200 is connected, if a signal strength of the wireless network base station still does not meet the default condition, network channel continues to be switched or another wireless network base station 200 is connected until a signal strength meets the default conditions to complete the transaction procedure.

In some embodiments, the communication module 10 is randomly connected to a network signal of one of the wireless network base stations 200. In some embodiments, according to the user's selection, the communication module 10 may connect to the wireless network base station 200 selected by the user.

In some embodiments, when a quantity of users connected to the wireless network base station 200 exceeds a default value, the processing module 40 can automatically switches the network signal connected to the other wireless network base stations 200. Further, if too many users are connected to the wireless network base station 200 at the same time, the processing module 40 can automatically switch to other wireless network base stations 200 until the quantity of users connected to the wireless network base station 200 is less than the default value.

The display module 50 is preferably a display screen and can be configured to display various pieces of information for the user to watch. In some embodiments, the display module 50 may be a touch-sensitive display screen and is configured to receive various operation inputs of the user. Herein, the display module 50 displays prompt information according to the prompt signal, or displays warning information according to the warning signal. For example, a light flashes, a window pops out, or a sound effect is produced to achieve a prompt or warning effect.

In some embodiments, when the transaction module 20 is performing the transaction procedure, the processing module 40 re-drives the detection module 30 to perform the detection procedure at intervals of a default time. Further, the detection module 30 detects, at intervals of a default time, whether the signal strength of the wireless network base station 200 meets the default condition, to preventing insufficient signal strength from affecting the performing of the transaction procedure. In some embodiments, a preset time is preferably 0.5 seconds, 1 second, or 2 seconds, and the preset time may be set according to a requirement of the user.

In some embodiments, when the transaction module 20 does not perform the transaction procedure, the processing module 40 continues to drive the detection module 30 to perform the detection procedure to detect the signal strength of the wireless network base station 200. Based on this, the display module 50 displays a network status message according to the signal strength, for example, a quantity of grid patterns is used to display the signal strength, or different color patterns are used to display the signal strength. In some embodiments, the detection module 30 may also perform detection at intervals of a preset time. Because the transaction procedure is not being performed at this time, the default time can be set to a larger arbitrary quantity of seconds according to a requirement of the user to reduce energy consumption of the portable point-of-sale terminal 100. In some embodiments, the detection module 30 can also turn off a detection function of the detection module according to a requirement of the user when the transaction procedure is not performed.

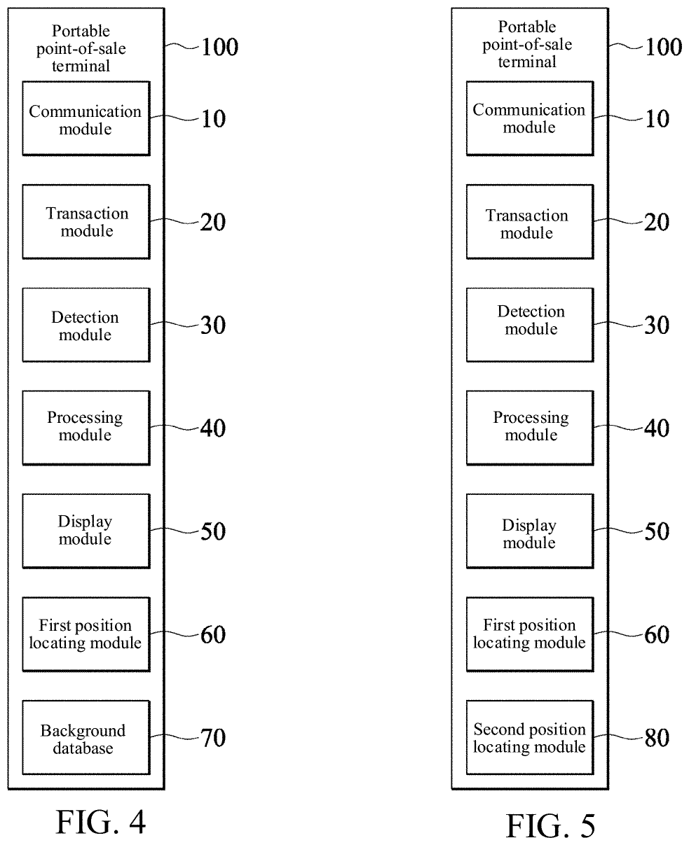

Referring to FIG. 3, FIG. 4, and FIG. 5, FIG. 3 is a block diagram of a portable point-of-sale terminal according to another embodiment of the present invention. FIG. 4 is a block diagram of a portable point-of-sale terminal according to still another embodiment of the present invention. FIG. 5 is a block diagram of a portable point-of-sale terminal according to yet another embodiment of the present invention.

In some embodiments, the portable point-of-sale terminal 100 further includes a first position locating module 60. The first position locating module 60 can locate a position of the wireless network base station 200 according to the signal strength of the wireless network base station 200. Based on this, the display module 50 displays map information and the position of the wireless network base station 200 in the map information. For example, the display module 50 may display a spatial layout map. After the first position locating module 60 locates the position of the wireless network base station 200 according to the signal strength, the display module 50 displays the located position on the spatial layout map.

In some embodiments, the portable point-of-sale terminal 100 further includes a background database 70. The background database 70 may preferably be a computer host or a server, and can be configured to store various pieces of data. Herein, the background database 70 may be configured to store the position information of the wireless network base station 200 in advance. Thereafter, when the communication module 10 is connected to one of the wireless network base stations 200 for communication, the first position locating module 60 can locate the position of the connected wireless network base station 200 according to the position information stored in the background database 70. In some embodiments, the display module 50 displays the map information, and displays the position of the connected wireless network base station 200 in the map information.

In some embodiments, the user may input position information of each wireless network base station 200 through the portable point-of-sale terminal 100, for example, position coordinates of the wireless network base station 200. In some embodiments, the user can hold the portable point-of-sale terminal 100 to a position in which each wireless network base station 200 is placed, and perform coordinate locating and input position information in a check-in manner.

In some embodiments, the portable point-of-sale terminal 100 further includes a second position locating module 80. The second position locating module 80 obtains position information of the wireless network base station 200 according to a 3G, 4G, or 5G signal. Based on this, the first position locating module 60 locates the position of the wireless network base station 200 according to the signal strength and the position information, that is, the position information obtained by the second position locating module 80 is used to assist the first position locating module 60 in locating.

According to the present invention, when the payment information is read through the transaction module to conduct a transaction, and the wireless network signal strength is equal to or lower than the default value, the processing module can switch the network signal connected to the other wireless network base stations to maintain stability of an electronic transaction. Therefore, a situation in which a failure in the transaction procedure is caused because a conventional Wi-Fi signal is not strong enough, or a channel is occupied by too many users is resolved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable point-of-sale terminal, comprising:
a communication module configured to search for a network signal of a plurality of wireless network base stations in a use environment, and connect to one of the wireless network base stations for communication after the network signal is found;
a transaction module configured to perform a transaction procedure, the transaction procedure being performed through the communication module and a remote financial institution when payment information is received;
a detection module configured to perform a detection procedure, the detection procedure being used for detecting a signal strength and a network channel of the wireless network base station received by the communication module;
a processing module configured to: when the transaction module starts the transaction procedure, drive the detection module to perform the detection procedure; and when the detection module detects that the signal strength meets a default condition, allow the transaction module to complete the transaction procedure, and generate a prompt signal; or when the detection module detects that the signal strength does not meet the default condition, generate a warning signal, drive the communication module to switch the network channel or drive the communication module to connect to another wireless network base station, re-drive the detection module to perform the detection procedure, and allow the transaction module to complete the transaction procedure until the signal strength meets the default condition; and
a display module configured to display prompt information according to the prompt signal or display warning information according to the warning signal.

2. The portable point-of-sale terminal according to claim 1, wherein when the transaction module does not perform the transaction procedure, the processing module drives the detection module to detect the signal strength of the wireless network base station received by the communication module, and the display module displays a network status message according to the signal strength.

3. The portable point-of-sale terminal according to claim 1, wherein when the transaction module is performing the transaction procedure, the processing module re-drives the detection module to perform the detection procedure at intervals of a default time.

4. The portable point-of-sale terminal according to claim 1, further comprising: a first position locating module configured to locate a position of the wireless network base station according to the signal strength, the display module displaying map information and the position of the wireless network base station in the map information.

5. The portable point-of-sale terminal according to claim 4, further comprising: a background database configured to store position information of the wireless network base stations, the first position locating module obtaining the position information of the wireless network base stations through the communication module, and when the communication module is connected to the one of the wireless network base stations for communication, the first position locating module locating the position of the wireless network base station to which the communication module is connected.

6. The portable point-of-sale terminal according to claim 4, further comprising: a second position locating module configured to obtain position information according to a global positioning system and a 3G, 4G, or 5G signal, the first position locating module locating the position of the wireless network base station according to the signal strength and the position information.

7. The portable point-of-sale terminal according to claim 4, wherein when a quantity of users connected to the wireless network base station exceeds a default value, the processing module automatically switches the network signal connected to the other wireless network base stations.
